(19) United States
(12) Patent Application Publication
(10) Pub. No.: US 2023/0396018 A1
(43) Pub. Date: Dec. 7, 2023

(54) CONNECTING BRIDGE AND ARRANGEMENT COMPRISING THE CONNECTING BRIDGE AND AT LEAST ONE BUSBAR

(71) Applicant: Weidmüller Interface GmbH & Co. KG, Detmold (DE)

(72) Inventor: Jan MEIER, Detmold (DE)

(21) Appl. No.: 18/323,953

(22) Filed: May 25, 2023

(30) Foreign Application Priority Data
Jun. 7, 2022 (DE) 10 2022 114 293.0

(51) Int. Cl. H01R 13/627; H01R 9/26; H01R 31/08

(52) U.S. Cl. CPC H01R 13/6272; H01R 9/2675; H01R 31/08

(57) ABSTRACT

A connecting bridge for the transmission of an electrical current between two electrically conducting components has at least two U-shaped cross-connectors each composed of electrically conductive sheet metal which are arranged nested in one another. An arrangement includes the connecting bridge and at least one busbar.

This application claims priority of DE 10 2022 114 293.0 filed on Jun. 7, 2022, the entire content of which is incorporated herein by reference.

### BACKGROUND OF THE INVENTION

The present invention relates to an electrical connecting bridge and an arrangement comprising such an electrical connecting bridge.

Connecting bridges are known in the prior art. They serve to connect two electrically conducting components, in particular busbars.

Several variants of connecting bridges which differ widely from one another in terms of structure are known from the prior art.

A connecting bridge which is formed in one piece and connects two busbars to one another is known from DE41 32 407 A1.

U.S. Pat. No. 2,857,583 A discloses a clamping element with injection-moulded u-shaped wires.

Further variants of connecting bridges are described in DE 3 625 240 A1, EP 0 123 822 B1, DE 20 2013 005 674 U1 and EP 0 396 808 A1.

### SUMMARY OF THE INVENTION

The object of the present invention is to provide a novel connecting bridge which enables optimized connection to a busbar and a secure transmission of current from one component to a different component. The connecting bridge preferably has at least two U-shaped cross-connectors which are arranged so as to be nested inside each other.

In contrast to, for example, wires, the cross-connectors are formed from an electrically conducting sheet metal so that the cross-connectors can be provided with contours, such as with a holding device, for example. In contrast, wire elements can only be used as plug connectors.

As a result of this, more optimised contacting properties can be achieved alongside simultaneously improved connecting forces. Further advantages will become apparent from the following description.

The connecting bridge can advantageously have a holding device for mounting in a clamping and/or latching manner, for instance on a busbar, preferably in the form of spring legs.

Each of the cross-connectors, in particular respectively the cross-connector legs of the U-shaped cross-connector, can have a holding device arranged terminally.

The holding device of each cross-connector can be formed in particular with the same shape so that the holding forces are comparable.

The cross-connectors are formed concentrically to one another in their nested design.

The cross-connectors are preferably mechanically connected to one another. This can be performed, for example, by overmoulding with plastic.

The cross-connectors are formed so as to be capable of being plugged onto a busbar in a plug-on direction.

At the same time, the cross-connectors can be arranged flush with one another perpendicular to the plug-on direction. This means that they have different lengths in the case of a nested arrangement and flush termination.

The cross-connectors are likewise arranged flush with one another along their width, perpendicular to the plug-on direction.

The nested arrangement preferably occurs such that a first outer cross-connector defines a free space as a result of its U-shape, with a second inner cross-connector being arranged within this free space.

As described above, the cross-connectors can have different lengths. Preferably, the outer cross-connector has a greater length than the inner cross-connector.

Each cross-connector can have two cross-connector legs, wherein each of the cross-connector legs has a plug-in slot which is arranged in such a manner that the plug-in slot splits the cross-connector leg into at least two partial legs. These partial legs are preferably formed as spring legs and, more so, as clamping legs. A spring leg of a metallic component has, up to a certain degree of deformation, an elasticity with the formation of a restoring force. Beyond the degree of deformation, plastic deformation occurs.

In the case of several cross-connectors arranged on top of one another, the plug-in slots advantageously and preferably have the same length such that comparable restoring forces act for the spring legs of the individual cross-connectors.

In this case, the length of the plug-in slots can, advantageously for building up an increased spring action, extend over at least 50% of the length of the cross-connector legs and preferably at least 65% of the length of the cross-connector legs.

The plug-in slots of the cross-connectors arranged in a nested manner can advantageously be formed with the same shape and arranged flush on top of one another. Thus, as a result of the nested arrangement, several current paths are provided which engage with comparable holding forces on a busbar.

Each of the cross-connectors comprises a base plate which is arranged between the cross-connector legs. The cross-connectors are preferably held in a nested arrangement at least in the region of the base plate.

Each of the cross-connector legs can advantageously have bevelled ends as lead-in chamfers to facilitate plugging onto a busbar.

A recess and, adjoining this, a projection can furthermore advantageously be arranged in the region of the plug-in slot of a cross-connector, wherein the projection defines a contact region to the electrically conducting component. As a result of this, the contact region is spatially defined.

A cross-connector can furthermore have a contact region with an adjacent cross-connector, preferably with direct electrical contact to an adjacent cross-connector. In this case, the contact region can occupy at least 60% and preferably between 70-99% of the surfaces which face one another.

Alternatively, or additionally, in the contact region there can be indirect contact between the adjacent cross-connectors, wherein there is provided in the contact region an isolation element, preferably an isolation layer, which is arranged at least in regions between the adjacent cross-connectors.

The cross-connectors connected to one another can have bending angles of different sizes in the region of the bends in the transition between the base plate and the cross-connector legs, wherein the bending angles of the outer cross-connector are preferably smaller than the bending angles of the inner cross-connector. As a result of this, play for tolerance compensation can arise.

The cross-connectors composed of a conductive sheet metal can preferably be manufactured with at least one or more of the following material values:
a modulus of elasticity of at least 130 GPa and/or
a tensile strength Rm of at least 420 MPa and/or
a yield strength Rp0.2 of less than 380 MPa.

The cross-connectors can preferably be manufactured from a conductive sheet metal of a copper alloy, preferably from a tin-plated sheet metal.

An arrangement including a connecting bridge according to the invention and at least one busbar which is connected mechanically and electrically to the connecting bridge is furthermore provided.

### BRIEF DESCRIPTION OF THE DRAWINGS

The invention will be explained in greater detail below using embodiments with the aid of the accompanying figures in which:

FIG. 1 is a perspective view of an electrical arrangement including two electrically conducting components and a connecting bridge according to the present disclosure;

FIG. 2 is a perspective view of the electrical arrangement from FIG. 1 with the connecting bridge in a partially mounted state;

FIG. 3 is a perspective view of a cross-connector of the connecting bridge from FIGS. 1 and 2;

FIG. 4 is a perspective view of an arrangement composed of two cross-connectors;

FIG. 5 is a perspective view of an arrangement composed of three cross-connectors;

FIG. 6 is a perspective view of an electrical connecting bridge;

FIG. 7 is a perspective view of a connecting bridge according to an embodiment of the present disclosure;

FIG. 8 is a side view of the cross-connector or of an arrangement of cross-connectors according to the present disclosure;

FIG. 9 is a sectional view of a connecting bridge being used according to the disclosure;

FIG. 10 is a perspective view of an arrangement according to the present disclosure; and

FIG. 11 is a sectional view of FIG. 10.

### DETAILED DESCRIPTION

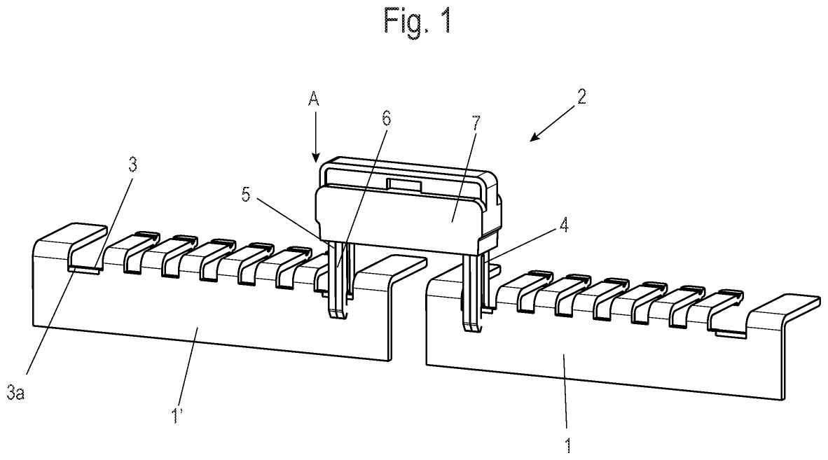

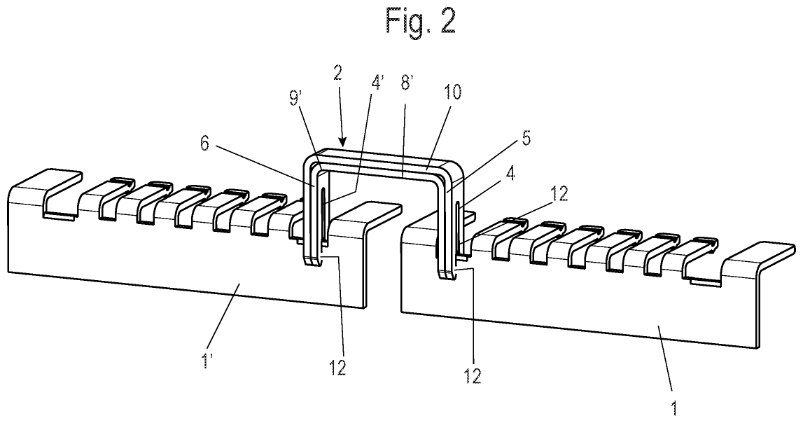

FIGS. 1, 2 and 9 show an electrical arrangement, including two electrically conducting components 1 and 1′ which are first and a second busbars.

The busbars have a strip-shaped base body and contact tongues at an angle thereto. A plug-in location 3 onto which a cross-connector leg 13, 14 of a cross-connector 5, 6, 23 of a connecting bridge 2 can be plugged is arranged between two adjacent terminal contact tongues. The plug-on direction A of the connecting bridge 2 onto the busbar 1 is shown in FIG. 1.

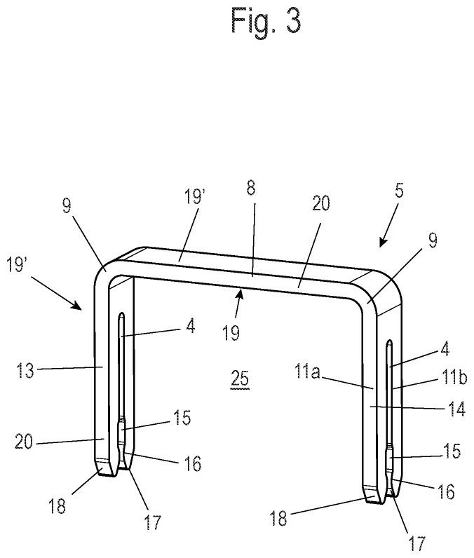

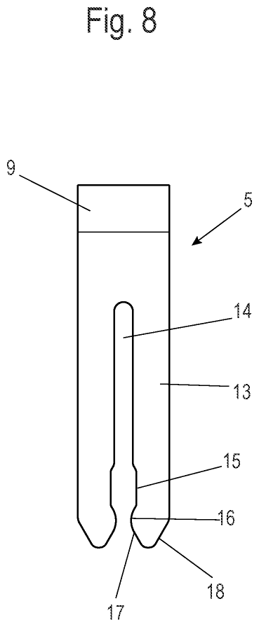

The connecting bridge 2 is preferably formed as a clamping connector, but other types of fixing such as a latching connection, are also conceivable. The connecting bridge and individual cross-connectors arranged nested in one another are represented in FIGS. 3-8.

The connecting bridge 2 has two cross-connectors 5, 6 which are manufactured from electrically conducting sheet metal. For example, steel, copper or similar material can be used.

Respective cross-connectors 5, 6 has a base plates 8 and two cross-connector legs 13, 14 which extend terminally at an angle therefrom. The cross-connector legs 13 and 14 preferably extend at a 90° angle with respect to the base plate 8 and are preferably angled with respect to the base plate 8. Cross-connector 6 including the base plate 8 and the cross-connector legs 13, 14 are constructed in one piece. In this case, the base plate 8 in the region of a bend 9 merges into the cross-connector leg 13, 14.

The cross-connectors 5, 6 and also the connecting bridge 2 have a U-shaped contour, wherein the first cross-connector 5 is larger and preferably has a greater total length than the second cross-connector 6.

The U-shape of the larger and preferably longer cross-connector 5 defines a partially open free space 25, wherein the opening of the free space 25 is arranged in the region between the ends of the cross-connector legs 13 and 14.

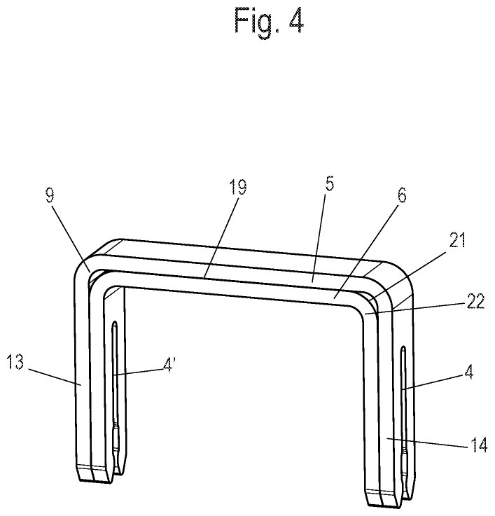

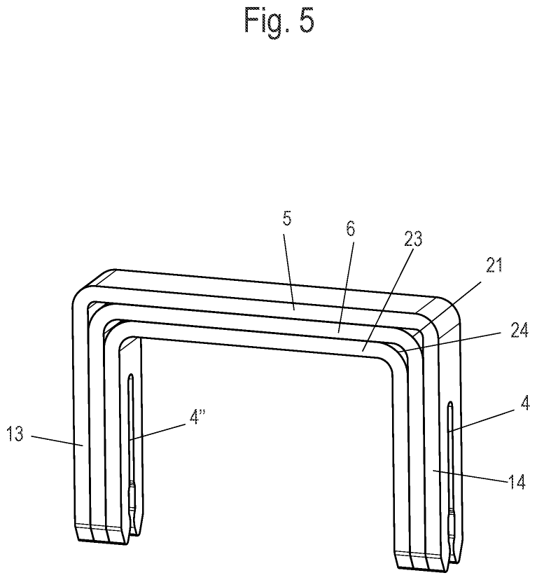

The first, second and third cross-connectors 5, 6, 23 and are shown arranged nested in one another in FIG. 5. The cross-connector 6 is preferably arranged inside the free space 25 of the cross-connector 5 and concentrically to the cross-connector as shown in FIG. 4. The same applies to the optional cross-connector 23 which in turn is arranged in a partially open free space defined by the U-shape of the cross-connector 6 concentrically with respect to the cross-members 5 and 6.

The cross-connector legs 13 and 14 of the cross-connectors 5, 6 and of the optionally further cross-connector 23 have in each case a plug-in slot 4, 4′ or 4″. The cross-connector legs 13 and 14 of the cross-connectors 5, 6 23 lie flush on top of one another and terminate likewise.

The plug-in slots 4, 4′, 4″ of the cross-connector legs 13 and 14 of the cross-connectors 5, 6, 23 preferably have the same dimensions in terms of length and are arranged on top of one another.

In particular, the plug-in slots 4, 4′, 4″ have identical contours to one another and are arranged on top of one another so that a uniform slot contour is produced in the stacking direction of the cross-connector legs 13. The plug-in slot 4, 4′, 4″ preferably extends over at least 50%, preferably more than 60%, of the length of the respective cross-connector leg 13, 14.

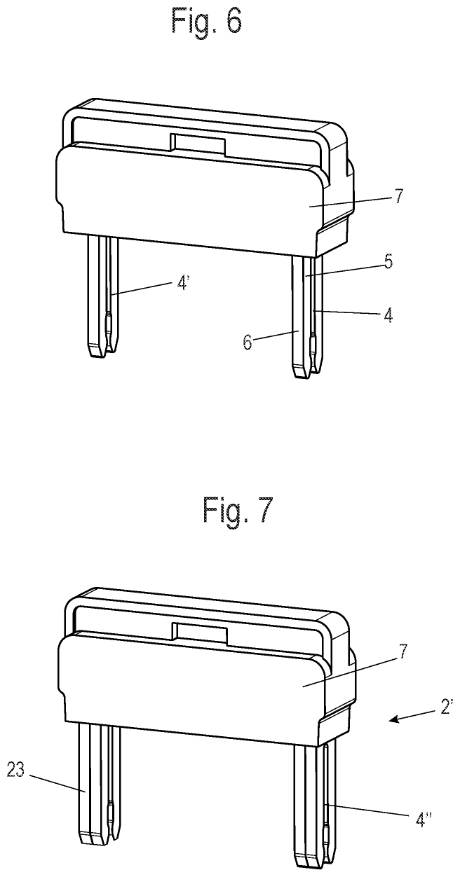

As shown in FIGS. 6 and 7, the cross-connectors 5, 6, 23 can be connected via an edging 7, for example, a plastic cap. The edging 7 is preferably arranged in the region of the base plates 8 of the respective cross-connectors 5, 6, 23.

The cross-connectors 5, 6, 23 differ from one another in terms of their length, in particular the length of the respective base plate 8 and the cross-connector legs 13 and 14. The width of the cross-connectors 5, 6, 23 is identical, hence the cross-connectors are flush when in a nested arrangement.

The cross-connectors 5, 6, 23 differ in terms of the bending radius of the bent portions 9, 9′. The outer or longest cross-connector 5 can thus have a smaller bending radius in the region of the bend 9, 9′ than the cross-connector 6 arranged nested in the cross-connector 5. The intermediate region 21 arising from this enables a certain degree of play, e.g. for length compensation in the case of different temperatures or in the case of production-related variance of the cross-connectors.

The cross-connectors 5, 6 are, in the nested arrangement, connected to one another in a flush manner both in the region of the base plate 8 and in the region of the cross-connector legs 13, 14. An isolation layer or an isolator, can be arranged between the cross-connectors 5, 6.

The cross-connectors 5, 6 can nevertheless, in the case of arrangement without an isolator, define a contact region 12 which occupies at least 60%, preferably between 70-99%, of the surfaces that face one another of the cross-connectors 5, 6.

The plug-in slot 4, 4′ splits the cross-connector leg 13, 14 terminally into two opposing spring legs which are formed as clamping legs 11 or 11a and 11b and which, as a result of their being composed of metal, are formed to be elastically deformable in the case of a low degree of deflection. The spacing of the clamping legs 11 varies in the direction of the width of the cross-connector 5, 6 in the event of the expending of a deformation force or in the event of deformation with the formation of a restoring force which enables jamming and/or latching.

The contours of the spring legs, preferably the clamping legs 11a, 11b, are formed in each case with the same shape. They have a rectilinear profile over most of the length of the plug-in slot 4, 4′, 4″. In the direction of the ends of the clamping legs, the clamping leg 11a has a recess 15 on the surface opposite the corresponding clamping leg 11b. A projection 16 adjoins this recess. Towards the end of the clamping leg 11a and 11b, the clamping leg tapers with two lead-in chamfers, or bevelled ends 17 and 18, which extend towards one another.

The cross-connector leg 5 has two surfaces 19, 19′ on opposite sides of the cross-connector leg, on which surfaces 19, 19′ a further cross-connector leg 6 can be arranged.

The cross-connector 5 furthermore has two side edge surfaces 20 which are located on the outside, preferably perpendicular, relative to the box or stack direction.

The bending radius of the bends 9 of the respective cross-connectors 5, 6, 23 increases with decreasing length of the respective further cross-connector. As a result of this, further intermediate regions 24 are formed in the region of the bends 9.

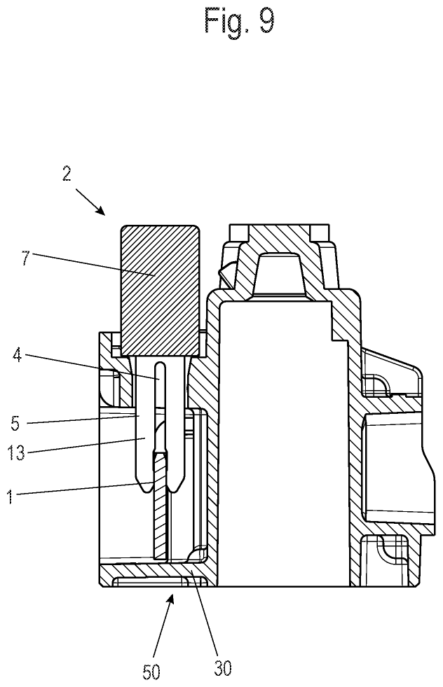

FIG. 9 shows the connecting bridge 2 described above in use. Here, a busbar 1 of an electronic arrangement 30 is positioned in regions in the plug-in slot 4 so that the clamping legs 11a and 11b are bent on against one another and form a restoring force. As a result of this, the connecting bridge is held on the busbar 1. The busbar is part of a terminal 30 of a terminal row arrangement 50.

The above-mentioned embodiment variant of a connecting bridge 2 according to the invention has numerous advantages. In the case of electrical contacting of the busbar 1 on both sides, the cross-connector legs 13, 14 engage around the busbar in a U-shape.

Since the individual cross-connector legs 13 and 14 are nested in one another or on top of one another, individual current paths from contact point to contact point of two busbars can be established. Faulty contacting does not interrupt the supply of current, rather it is merely reduced or leads to an increase in the contact resistance.

The front contact regions of the clamping legs 11a, 11b are grasped to better push the cross-connector onto the busbar.

In this case, the clamping legs 11a and 11b of the cross-connector legs 13, 14 have resilient properties, at least in the contact region with the busbar 1.

One particular advantage of the modular structure composed of several cross-connectors of a nested design in a connecting bridge 2 is the scalability via the number of several independent U-shaped contact systems to influence the contact resistance. This contact resistance should be as low as possible. The more contact points provided, the lower the contact resistance.

More contact points, and thus a higher contact cross-section, are provided by the multiplicity of cross-connectors 5, 6, 23.

The cross-connectors 5, 6, 23 of the connecting bridge 2 can be electrically connected to one another, but do not have to be. If there is an electrical connection, elevated temperature can arise at the contact points.

The handle region is provided as an edging 7 which can be formed as an overmoulding of the cross-connectors or as a housing, in particular as a cap.

The material of the cross-connector is conductive sheet metal, preferably a copper alloy and particularly with a partially or fully tin-plated surface.

A tolerance compensation of clamping forces can be achieved by the modular separation into several cross-connectors. Several cross-connectors can be used depending on the requirements in terms of clamping forces.

The connecting bridge can furthermore be equipped in an application-specific manner. This means that, through the number and the material of the cross-connectors, they can be adapted to the requirements in terms of the respective application, for example, until the desired contact resistance is reached or a desired clamping force is applied. Power loss and a drop in temperature during current transmission likewise arise from this.

The following material characteristic values are particularly preferred for the material of a cross-connectors:
a modulus of elasticity of at least 130 GPa;
a tensile strength Rm of at least 420 MPa; and/or
a yield point—Rp0.2—is less than 380 MPa.

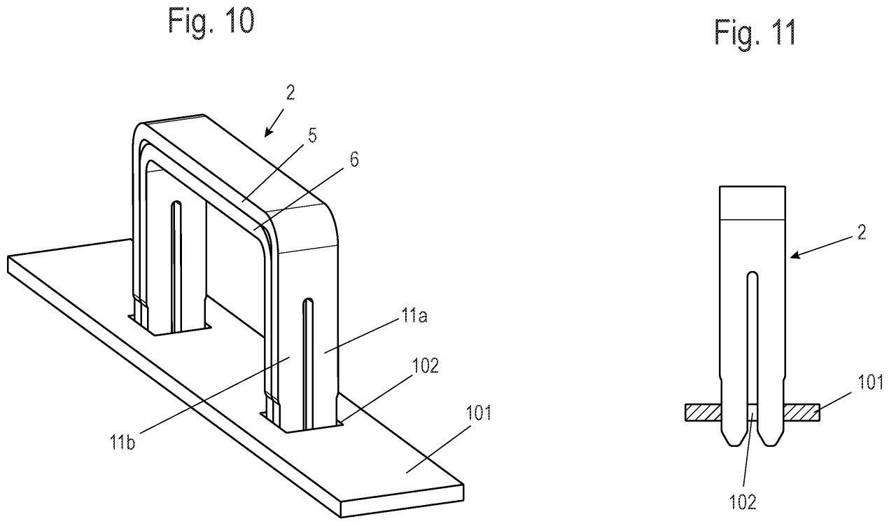

FIGS. 10 and 11 show a further arrangement according to the invention, including a busbar 101, in which the connecting bridge 2 is not plugged-on, but rather is plugged into a receiving opening 102. The connecting bridge 2 is formed in this case in an analogous manner to the above embodiment variants.

For the purpose of connection to the busbar 101, both spring legs are pressed against one another and guided through the receiving opening so that they project partially out of the side, opposite the introduction side, of the busbar.

The restoring force with which the connecting bridge 2 is positioned in the connecting opening 102 is determined in this case by the number of cross-connectors 5, 6 arranged on top of one another.

What is claimed is:

1. A connecting bridge for the transmission of an electrical current between two electrically conducting components, comprising at least two U-shaped cross-connectors composed of electrically conductive metal arranged nested inside each other.

2. The connecting bridge according to claim 1, wherein the connecting bridge has a holding mechanism for mounting in at least one of a clamping and latching manner.

3. The connecting bridge according to claim 2, wherein holding mechanisms are terminally arranged on each cross-connector.

4. The connecting bridge according to claim 3, wherein the holding mechanism of each cross-connector has the same shape.

5. The Connecting bridge according to claim 3, wherein the cross-connectors are arranged concentrically to one another.

6. The connecting bridge according to claim 3, wherein the cross-connectors are mechanically connected to one another.

7. The connecting bridge according to claim 3, wherein the cross-connectors are configured to be plugged onto a busbar in a plug-on direction.

8. The connecting bridge according to claim 3, wherein the cross-connectors are configured to be plugged into a receiving opening of a busbar.

9. The connecting bridge according to claim 7, wherein the cross-connectors are arranged flush with one another perpendicular to the plug-on direction.

10. The connecting bridge according to claim 7, wherein the cross-connectors are arranged flush with one another in the direction of a width of the cross-connectors.

11. The connecting bridge according to claim 1, wherein the U-shape of a first outer cross-connector defines a free space, a second inner cross-connector being arranged within the free space.

12. The connecting bridge according to claim 11, wherein the cross-connectors have different lengths, the outer cross-connector having a greater length than the inner cross-connector.

13. The connecting bridge according to claim 1, wherein each cross-connector has two cross-connector legs having a plug-in slot arranged between the cross-connector legs.

14. The connecting bridge according to claim 13, wherein the plug-in slots of several cross-connectors arranged on top of one another have the same length.

15. The connecting bridge according to claim 13, wherein the length of the plug-in slots extends over at least 50% of the length of the cross-connector legs.

16. The connecting bridge according to claim 13, wherein the plug-in slots of cross-connectors arranged in a nested manner have the same shape and are arranged flush on top of one another.

17. The connecting bridge according to claim 13, wherein each of the cross-connectors has a base plate between the cross-connector legs and wherein the cross-connectors are arranged in a nested manner at least in the region of the base plate.

18. The connecting bridge according to claim 13, wherein each of the cross-connector legs has bevelled ends.

19. The connecting bridge according to claim 13, wherein the plug-in slots have a recess and adjoining projection, the recess and projection providing a contact region to an electrically conducting component.

20. The connecting bridge according to claim 13, wherein a cross-connector has a contact region arranged adjacent with a contact region of corresponding cross-connector.

21. The connecting bridge according to claim 20, wherein the contact region occupies at least 60% of the surfaces of the cross-connectors.

22. The connecting bridge according to claim 20, wherein the contact region includes indirect contact between adjacent cross-connectors, wherein the contact region includes an isolation element which is arranged between the adjacent cross-connectors.

23. The connecting bridge according to claim 17, wherein the cross-connectors connected to one another have angles of different degrees in the transition between the base plate and the cross-connector legs, wherein the angles of the outer cross-connector are preferably less than the angles of an inner cross-connector.

24. The connecting bridge according to claim 1, wherein the cross-connectors are composed of a conductive sheet metal, preferably with at least one or more of:
a modulus of elasticity of at least 130 GPa;
a tensile strength Rm of at least 420 MPa; and
a yield strength Rp0.2 of less than 380 MPa.

25. The connecting bridge according to claim 24, wherein the cross-connectors are composed of a conductive sheet metal of a copper alloy.

26. An arrangement comprising a connecting bridge according to claim 1 and at least one busbar connected mechanically and electrically with the connecting bridge, by one of being plugged onto the busbar or plugged in a receiving opening of the busbar.
